(19) United States
(12) Patent Application Publication
(10) Pub. No.: US 2013/0198641 A1
(43) Pub. Date: Aug. 1, 2013

(54) PREDICTIVE METHODS FOR PRESENTING WEB CONTENT ON MOBILE DEVICES

(71) Applicants: Sean T. Brownlow, Rochester, MN (US); Nathan G. Faiman, Rochester, MN (US); Michael T. Kalmbach, Elgin, MN (US); John E. Petri, St. Charles, MN (US); Kevin Wendzel, Rochester, MN (US)

(72) Inventors: Sean T. Brownlow, Rochester, MN (US); Nathan G. Faiman, Rochester, MN (US); Michael T. Kalmbach, Elgin, MN (US); John E. Petri, St. Charles, MN (US); Kevin Wendzel, Rochester, MN (US)

(73) Assignee: INTERNATIONAL BUSINESS MACHINES CORPORATION, Armonk, NY (US)

(21) Appl. No.: 13/361,632

(22) Filed: Jan. 30, 2012

(51) Int. Cl. G06F 3/048

(52) U.S. Cl. 715/738

(57) ABSTRACT

Once a computing device receives a request to display a webpage, the device may use criteria to determine the portion of the page that is likely to be the most relevant to the user. The computing device may then zoom in (i.e., adjust the relative size and position of the elements in the webpage) and pan or scroll through the webpage such that the most relevant portion is displayed. Additionally, the computing device may superimpose on the displayed portion of the webpage links that represent other portions of the webpage that are currently not displayed but are relevant to the currently displayed portion. Selecting a link causes the computing device to display the corresponding portion. Furthermore, as the user zooms out, the computing device may also highlight hotspots or points of interests for the new content that is being displayed.

### BACKGROUND

1. Field of the Invention

The present invention generally relates to displaying content of a webpage, or, more specifically, to zooming or panning to relevant content of the webpage.

2. Description of Related Art

As computing devices become more mobile, the display screens have shrunk to increase the portability of the devices. In many cases, users of these computing devices rely on them to access the same webpages that are configured for display on more traditional laptop or desktop computers. Many websites have created streamlined versions of the site for display on the small screens of smartphones, tablet computers, e-readers and the like. However, visiting webpages that have not been optimized for display of mobile devices may lead to inefficiencies.

In one example, a computing device with a small screen (e.g., less than 8 inches) may attempt to display a non-optimized webpage at the same resolution as would be used with a regular monitor (e.g., 19 inches). In this case, the font of the webpage may be too small for the user to read. Accordingly, the user may have to first zoom in to read the text of the page.

In another example, a computing device may be configured (or be instructed by the webpage) to display the webpage at a maximum resolution or zoom setting. In the case of a computing device with a small screen, this maximum resolution results in only the top left corner of the webpage being displayed. From this view, the user must zoom out or pan around the webpage to find the portion she is interested in.

### SUMMARY

Embodiments of the invention provide a method, computer-readable storage medium, and a system of displaying a webpage on a screen of a computing device. The method, computer-readable storage medium, and system receive a command to display the webpage on the screen. The method, computer-readable storage medium, and system determine a size of a plurality of sub-portions of the webpage based on a minimum object size for displaying the object on the screen. The method, computer-readable storage medium, and system determine a user-interest score for each of the sub-portions based on at least one of: previous interactions with the webpage and a webpage element or a type of webpage element contained in the relevant portion. The user-interest score representing the likelihood that the user of the computing device is interested in the webpage elements contained in the sub-portions. The method, computer-readable storage medium, and system selecting a relevant portion from among the sub-portions based on the respective user-interest scores. Upon determining that the user-interest score for the relevant portion satisfies a predefined threshold, zooming in and panning the web page to display the relevant portion of the web page on the screen such that lateral and vertical dimensions of the webpage exceed both of the lateral and vertical dimensions of the screen, whereby an unviewable portion of the webpage comprises a lateral portion and a vertical portion of the webpage. After displaying the relevant portion of the webpage, the method, computer-readable storage medium, and system display a link in the screen that instructs the computing device to display in the screen a different portion of the webpage that is at least partially within the unviewable portion of the webpage. Upon determining that the user interacted with the link, the method, computer-readable storage medium, and system display in the screen the different portion of the webpage such that the relevant portion of the webpage is at least partially within the unviewable portion of the webpage.

### BRIEF DESCRIPTION OF THE DRAWINGS

So that the manner in which the above recited aspects are attained and can be understood in detail, a more particular description of embodiments of the invention, briefly summarized above, may be had by reference to the appended drawings.

It is to be noted, however, that the appended drawings illustrate only typical embodiments of this invention and are therefore not to be considered limiting of its scope, for the invention may admit to other equally effective embodiments.

FIG. 1 is a system for displaying webpage content on a computing device, according to one embodiment of the invention.

FIG. 2 is a flow chart describing a technique of zooming in to relevant portions of a webpage, according to one embodiment of the invention.

FIGS. 3A-3B illustrates the dimensions of a display screen and webpage, according to one embodiment of the invention.

FIG. 4 illustrates zooming to display a relevant portion of the webpage, according to one embodiment of the invention.

FIG. 5 is a flow chart describing a technique for displaying links to portions of the webpage that are not currently displayed, according to one embodiment of the invention.

FIG. 6 illustrates displaying links to relevant, unviewable portions of the webpage, according to one embodiment of the invention.

FIG. 7 illustrates panning or zooming to display a portion of the webpage based on a user interaction with a link, according to one embodiment of the invention.

FIG. 8 is a flow chart describing a technique for displaying points of interests, according to one embodiment of the invention.

FIG. 9 illustrates displaying points of interests on the display screen of the computing device, according to one embodiment of the invention.

### DETAILED DESCRIPTION

Instead of requiring a user to manually zoom or pan to locate relevant portions of a webpage, the embodiments discussed herein disclose automatically zooming or panning to a relevant portion of the webpage. Once a computing device receives a request to display a webpage, the device may use criteria to determine the portion of the page that is likely to be the most relevant to the user. The computing device may then zoom in (i.e., adjust the relative size and position of the elements in the webpage) and pan (i.e., lateral or vertical adjustment to change the displayed portion of the webpage) or scroll such that the most relevant portion is displayed. In the case where the computing device is unable to display a significant portion of the page, this allows the user to avoid having to manually zoom in and out and/or pan through the webpage to locate the relevant portion. For example, if the user typically zooms in and pans to a portion of the webpage where the user types in a username and password, the computing device may identify this user behavior and automatically display a zoomed in portion of the webpage once the user requests that the page be displayed.

Additionally, the computing device may superimpose on the displayed portion of the webpage links that represent other portions of the webpage that are not currently displayed but are similar or relevant to the webpage portion that is displayed. For example, if the user is viewing a video, the computing device may display a link to comments from other people who watched the video. Once the user interacts with the link (e.g., taps on the link using a touch screen display), the computing device may pan to bring the comments into the visible portion of the display.

The computing device may also permit a user to identify hotspots (i.e., points of interests) based on the content of the webpage she is currently viewing. For example, after viewing the content that the computing device determined was most relevant, the user may begin to manually zoom out to navigate to a different portion of the page. Upon detecting that the user is changing what is currently being displayed on the screen, the computing device may evaluate the content that is now displayed on the screen to determine if it is similar to what was displayed previously. If so, the computing device may mark the content as a hotspot. Even if the user had zoomed out where she could no longer read the content on the webpage, the hotspot may be superimposed on top of the webpage on the display screen such that it is still easily identified by the user. If the user interacts with the hotspot, the computing device may zoom in or pan to the webpage content corresponding to the hotspot.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

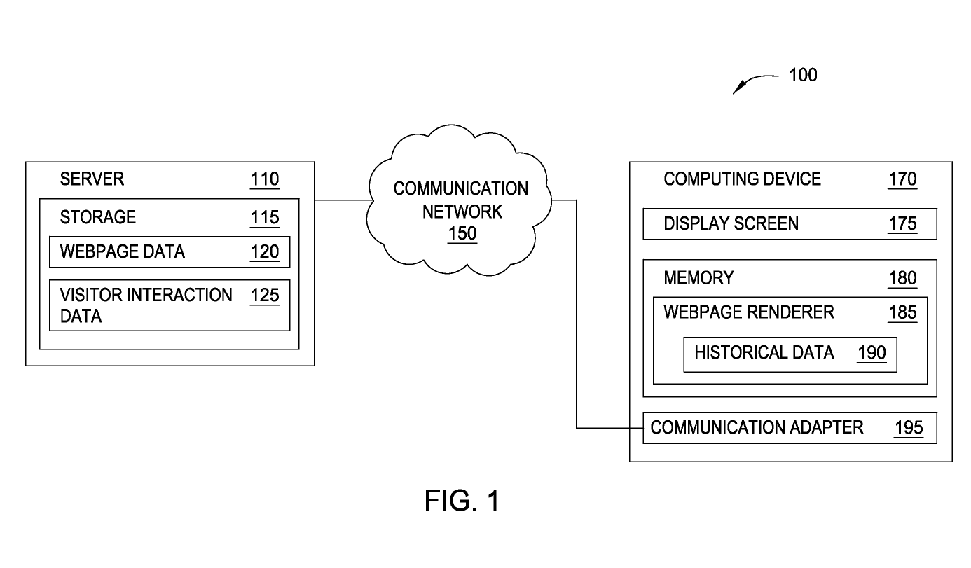

FIG. 1 is a system for displaying webpage content on a computing device, according to one embodiment of the invention. The system 100 includes a server 110, communication network 150 and computing device 170. In general the computing device 170 is communicatively coupled to the communication network 150 which permits the computing device 170 to transmit and receive data from the server 110. Specifically, the server 110 may be a web server that transmits data (e.g., HTML code) that enables the computing device 170 to display a webpage.

The computing device 170 may be any processor containing device that permits a user of the device to view and interact with a webpage—e.g., submit information to the server 110 via the webpage, zoom/pan/scroll throughout the webpage, access data sources using the webpage, and the like. The display screen 175 may be any type of screen (e.g., LCD, CRT, etc.) and may be integrated into the computing device or be a separate component. In one embodiment, the display screen 175 may be touch sensitive such that a user may use her finger or a special tool to interact with the webpage by contacting the display screen 175. Additionally or alternatively, the user may use a separate device such as a mouse, an integrated scroll ball, touch pad, and the like to interact with the displayed webpage.

The memory 180 represents random access memory (RAM) devices comprising the main storage of the computing device 170, as well as supplemental levels of memory, e.g., cache memories, non-volatile or backup memories (e.g., programmable or flash memories), read-only memories, and the like. The memory 180 includes a webpage renderer 185 for displaying a webpage on the display screen 175. The webpage renderer 185 may receive input from the user to change the view of the webpage (e.g., zoom in) or to input data into the webpage. The webpage renderer 185 determines the changes requested by the user and updates the image displayed on the screen 175 based on the user request. In one embodiment, the webpage renderer 185 may be part of a web browser on the computing device 170 or a plug-in that may enhance the functions of the browser.

The webpage renderer 185 may use the historical data 190 to identify and display relevant portions of the webpage to the user. If, for example, the display screen 175 is too small for a user to read the webpage at the current resolution, the webpage renderer 185 may use the historical data 190 to automatically zoom and/or pan to a portion that is most likely to be relevant to the user. The historical data 190 may include a log of previous actions performed by the user when she visited the webpage. For example, the log may indicate that 70% of the time the user visits the webpage, she typed in a username and password at a login portion of the webpage. Using the historical data 190, the webpage renderer 185 may identify the most relevant portion of the page for when the user first visits the webpage. In one embodiment, the webpage renderer 185 may contain a predefined threshold for determining the most relevant portion. If the historical data 190 includes an activity that reaches the threshold—e.g., the user performs the same activity at least 60% of the time—then the portion of the webpage that is associated with the action is deemed the most relevant portion to the user.

Specifically, the webpage renderer 185 may zoom in such that the texts or images in the relevant portion are more easily viewable by the user. In one embodiment, the degree to which the webpage renderer 185 zooms in or out depends on the display screen 175 size as well as the size of the relevant portion that is to be displayed. In general, the webpage renderer 185 establishes the amount of webpage content that can be displayed in the relevant portion based on a desired minimum size of the objects in the webpage—e.g., text, images, graphics or other elements. Thus, a user who wants a minimum text height of 1 cm can display less content in the relevant portion relative to a user who wants a minimum text height of 0.5 cm.

However, the embodiments disclosed herein are not limited to screens of mobile devices but may be used in larger screens (e.g., screens associated with laptops or desktop computers). For example, a user may use the automatic zooming and panning feature to highlight only the portion of the webpage that the user is most interested in.

The communication adapter 196 may comprise a network card configured for wired or wireless communication. For example, the communication network may include an Internet service provider (ISP) to which the communication adapter 196 is connected. The ISP provides the computing device 170 access to a WAN (e.g., the Internet). In one embodiment, the communication network 150 may include a cellular service provider. The computing device 170 may be a mobile device such as a smartphone, tablet computer, or laptop that is configured to connect to a cell tower in the communication network 150. Using the cellular service provider, the computing device 170 may transmit data to and receive data from the server 110.

The server 110 includes storage 115 which may represent random access memory (RAM) devices cache memories, non-volatile or backup memories (e.g., programmable or flash memories), read-only memories, magnetic storage devices (e.g., hard drives or tape drives) and the like. The storage 115 serves as a repository for storing the necessary data for displaying the webpage on the computing device 170. For example, the webpage data 120 may include the HTML code that the webpage renderer 185 may use to display the webpage. However, webpage data 120 may include any kind of data useful for displaying interactive webpages such as different types of HTML (e.g., Dynamic HTML or XHTML) or programming code (Java®, Flash®, and the like).

The server 110 also records visitor interaction data 125 associated with a webpage. The visitor interaction data 125 may record what actions visitors took once they visited the webpage. For example, after transmitting the webpage data 120 to a computing device, the server 110 may monitor the actions the user takes such as whether the user begins to stream a certain movie, clicks on a link, accesses a database, and the like. The webpage renderer 185 may use the visitor interaction data 125 to determine what action was most relevant to other visitors to a website, and thus, what portion may be relevant to the user of the computing device 170.

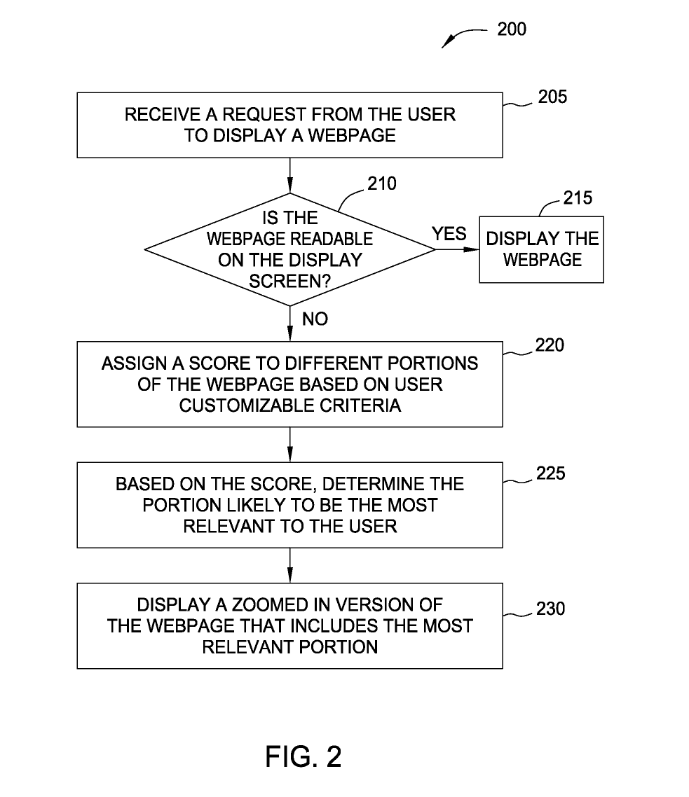

FIG. 2 is a flow chart describing a technique of zooming in to relevant portions of a webpage, according to one embodiment of the invention. At step 205, the computing device 170 determines that a user or an application of the device has instructed the computing device 170 to display a webpage on the display screen 175. This request may be received by a user typing in a URL into a browser, the user interacting with a link on a currently displayed webpage, by an application executing on the computing device, and the like.

In one embodiment, the computing device 170 transmits a request to the server 110 for the webpage data 120. The computing device 170 may also transmit identifying data that informs the server 110 whether the computing device 170 should receive webpage data 120 optimized for a smaller screen. For example, the indentifying data may state that the requesting device is a mobile device. Accordingly, the server 110 may transmit webpage data 120 that corresponds to a webpage optimized for mobile devices. If the server 110 does not include a webpage optimized for smaller screens, it may transmit the same webpage data 120 regardless of the type of the computing device sending the request. The method 200, however, may be used regardless of whether the webpage is optimized for mobile device if for larger display screens. Further, the method 200 may be applied to either mobile devices or devices with larger screens.

Before displaying the webpage, the webpage renderer 185 may determine whether the objects of the webpage (i.e., text and images) would be viewable by the user. That is, the webpage renderer 185 may include user customizable parameters that determine when a webpage is readable by the user. For example, the text of the webpage may be set to a minimum height relative to display screen 175 (e.g., text must be at least 1% of the height of the display screen 175). Additionally, the user may establish a maximum number of pixels that may be displayed in a predefined area of the display screen 175—i.e., a pixel density. If an image is formed using 100 pixels, as the pixel density of the display screen 175 increases, the size of the image on the screen 175 decreases. As used herein, “zooming out” typically means reducing the number of pixels used by texts or images such that the texts or images become smaller in the screen. This may also involve decreasing the spacing between the text or images such that the ratio of the size and the spacing of the text and images remains constant. Conversely, “zooming in” typically means increasing the number of pixels used by texts or images such that the texts or images become larger in the screen. Zooming in may also involve increasing the spacing between the text or images such that the ratio of the size and the spacing of the text and images remains constant. Alternatively, in some computing devices, increasing the pixel density and increasing the resolution of the display screen 175 are synonymous to zooming out while decreasing the pixel density and decreasing the resolution are synonymous to zooming in.

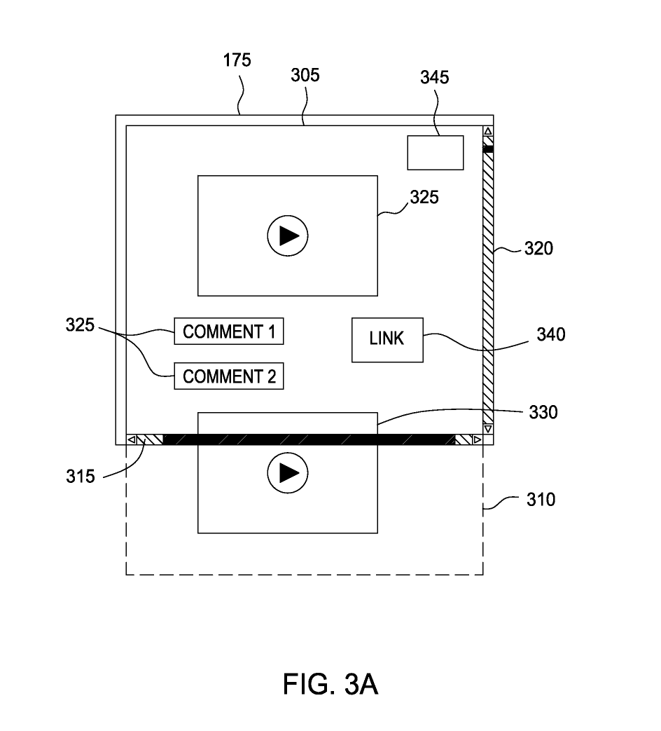

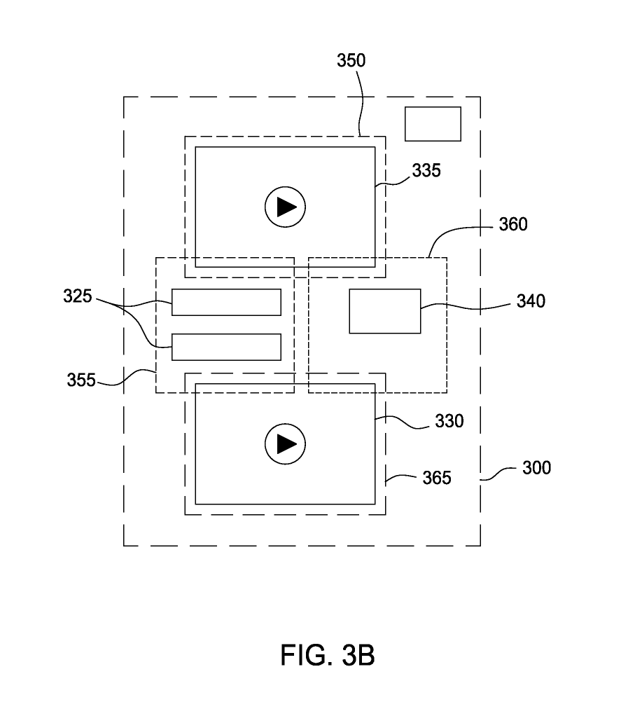

FIG. 3A illustrates the dimensions of a display screen and webpage, according to one embodiment of the invention. Specifically, FIG. 3A illustrates a display screen 175 that may display the content of the webpage such that it is unreadable to a user. Here, the webpage renderer 185 may be configured to select a zoom setting such that the entire width of the webpage fits within the width of the display screen 175. However, this zoom setting may shrink the text of the comments 325, link 340, and image 345 such that they are no longer understandable by the user. Specifically, the physical dimensions of the display screen 175 may be unable to display the content in a readable format. If the webpage were displayed on a larger display screen 175—e.g., a 19 inch monitor rather than a 4 inch display—then the comments 325, link 340, and image 345 may be displayed with a sufficient height and width to be readable by a user.

Many webpages are generated with the assumption that they will be viewed on display screens with physical dimensions sufficient enough to display the entire width of the webpage and still maintain readability. However, those same webpages when viewed on mobile devices may lose readability if the zoom setting is chosen to fit the width of the webpage to the width of the display screen. A user may be forced to zoom in to a specific area of the webpage to view the content of the webpage.

The boundaries of the webpage in FIG. 3A are extended to illustrate an unviewable portion 310 of the webpage. The ghosted lines outline the unviewable portion 310 of the webpage that may be accessed if the user zooms out, pans, or scrolls using the scroll bars 315, 320. The ghosted lines merely represent the entire dimensions of the webpage if the physical dimensions of the display screen 175 were increased to fit the entire webpage on the screen 175. In FIG. 3A, however, the zoom setting is set such that there is an unviewable portion 310 that extends beyond the dimensions of the screen 175. That is, the ghosted lines define dimensions of the webpage that may be greater than the dimensions of the display screen 175. Thus, a user viewing FIG. 3A would see only the viewable portion 305 of the webpage as outlined by the physical dimensions of the display screen 175. As shown, a portion of the video 330 would be in the viewable portion 305 while the rest of the video 330 would be in the unviewable portion 310 of the webpage. The entire webpage is defined as the combination of the viewable and unviewable portions 305, 310.

By panning or scrolling, the user may move content of the webpage from the unviewable portion 310 to the viewable portion 305. In one embodiment, panning or scrolling requires that whatever area of the webpage is taken from the unviewable portion 310 and placed in the viewable portion 305 corresponds to a same sized area being taken from the viewable portion 305 and placed in the unviewable portion 310. For example, scrolling down using the scroll bar 320 adds more of the video 330 to the viewable portion 305 but removes some of the webpage area located at the top of the viewable portion 305—e.g., image 345 or embedded video 335.

Zooming out, in contrast, may add content of the webpage to the viewable portion 305 without moving content to the unviewable portion 310. If the user zooms out, then more of the content of the webpage may be displayed in the screen 175. However, as mentioned previously, this may sacrifice the readability of the text or images in the webpage.

Zooming in may remove content of the webpage from the viewable portion 305 without adding any content from the unviewable portion 310. If the user zooms in relative to the center of the display screen 175, then webpage content located of the peripheral of the display screen 305 (e.g., image 345 and video 330) may be moved into the unviewable portion 310.

Before displaying the webpage, the webpage renderer 185 may predict the dimensions of the text and/or images of the webpage if they were displayed on the screen 175. The webpage renderer 185 may use thresholds that define a minimum dimension of the content. If, for example, the height of any text that would be displayed is less than one centimeter for the average height of the text, then the webpage renderer 185 may determine that the text is unreadable. A similar process may be followed to ensure that images are viewable to a user—e.g., establish a zoom setting that establishes minimum text or image dimensions (i.e., height and width) or a maximum resolution for the webpage. For example, the webpage data may define a resolution or zoom setting for displaying the content of the webpage. If that setting results in the height of the text being less than the minimum text height, then the webpage renderer 185 may deem the webpage content unreadable. In one embodiment, the thresholds may be customizable by the user—i.e., some users may prefer viewing smaller text or images than others.

In one embodiment, the webpage renderer 185 may detect when a webpage has been optimized for display on computing devices with smaller screens. In that case, the webpage renderer 185 may not need to check the thresholds but may automatically display the webpage.

Returning to step 210 of FIG. 2, if the webpage renderer 185 determines that a webpage is viewable, at step 215 it may display the page. However, in one embodiment, both steps 210 and 215 may be omitted from the method 200. That is, the webpage renderer 185 may perform steps 220-230 without first determining if the content of a webpage is readable.

At step 220, the webpage renderer 185 assigns a score to the different portions of the webpage based on the user's historical data 190, the actions of other visitors to the website, or the content or structure of the webpage. The user may customize which of these criteria to consider or provide weights if multiple criteria are considered.

Prior to assigning a score, in one embodiment, the webpage renderer 185 may divide up the webpage into different sub-portions. Because the webpage renderer 185 displays the sub-portion rather than what is shown in FIG. 3A, the zoom setting of the sub-portions may be selected to ensure that any text or images within the portion will be readable to the user. For example, the webpage renderer 185 or the user may require that any height of the text in the sub-portion must be at least 5% of total height of the screen. To accomplish this, the webpage renderer 185 may establish a minimum text or image height based on the size of the display screen 175. The webpage renderer 185 may also establish a minimum height for other webpage elements such as links or embedded video players. Note that setting these constraints limit how much content of the webpage can fit within each sub-portion.

After the webpage renderer 185 determines the zoom setting of the sub-portions, the webpage renderer 185 may use, for example, text analysis techniques to determine where to place a sub-portion. Specifically, the webpage renderer 185 may parse the text of the webpage to identify portions of text that may relate to the same topic. For example, the comments 325 may all pertain to the same topic. Thus, the webpage renderer 185 may identify a single sub-portion that encapsulates the comments 325. Similarly, link 340 may actually be a plurality of links to webpages that deal with the same topic. Using text analysis, the webpage renderer 185 may recognize that the content in the same general location on the webpage shares the same theme and arrange a sub-portion of the webpage to encapsulate the links.

FIG. 3B illustrates dividing up a webpage into sub-portions. Specifically, the webpage 300 is the same as the webpage illustrated in FIG. 3A but the display screen 175 has been removed for clarity.

The webpage renderer 185 may identify a sub-portion of the webpage by evaluating the different webpage elements in the webpage, such as the embedded videos 335 (i.e., sub-portion 350) or link 340 (i.e., sub-portion 3360). Each webpage element or group of elements may be used to generate a different sub-portion of the webpage.

Further, the webpage renderer 185 may identify sub-portions of the webpage based on user interaction with those portions. For example, if the user interacts with a link or views a portion of text for a predefined amount of time, the webpage renderer 185 may mark the portion of the webpage that contains the link or text as a sub-portion—i.e., sub-portion 355 and 360. Similarly, the webpage renderer 185 may use the actions of other visitors to the webpage to identify sub-portions.

However, the webpage renderer 185 may establish thresholds for determining whether to consider text or a webpage element as a sub-portion of the webpage. For example, if the text does not share a common theme, then it might be ignored. Similarly, if the image 345 is an advertisement, the webpage renderer 185 may be configured to ignore the portion of the webpage that includes the image 345.

As mentioned previously, in one embodiment, the amount of content that can fit into a sub-portion may be limited by the minimum dimensions for the contents of the webpage. If all text or the entire webpage element cannot fit in the sub-portion with these constraints, then that sub-portion may not be considered. That is, in this embodiment, a sub-portion must be able to fit in the display screen 175 and still be readable by the user. Alternatively, instead of excluding the sub-portion, the webpage renderer 185 may cut off the part of the sub-portion that does not fit in the screen—e.g., exclude some of the text or exclude the periphery of an embedded video—to ensure that the text or images are still readable to the user. Also note that the sub-portions may overlap as shown by sub-portions 355 and 350 and do not have to cover the entire webpage. Instead, the webpage renderer 185 may use the criteria discussed above to selectively place a sub-portion.

After the webpage renderer 185 identifies one or more sub-portions of the webpage, it assigns a score to each of the portions. In one embodiment, the webpage renderer 185 may use historical data 190 of the user's past interactions with the website. The webpage renderer 185 may record in the historical data 190, for example, whether the user scrolled to a certain part of the page, clicked on a link in the page, or entered text into a text-field on the webpage. Each action may be logged in the historical data 190 and associated with a sub-portion of the page. Based on these previous actions, the webpage renderer 185 can determine a score for the corresponding sub-portion of the page. For example, if 80% of the time the user visited the webpage she scrolled to read the same portion of text but only clicked on a certain link 50% of the time, the portion of the webpage with the text may receive a higher user-interest score than the portion of the webpage that includes the link.

In another embodiment, the webpage renderer 185 may consider the actions performed by others to assign a score to one of the sub-portions. Specifically, the computing device 170 may access the visitor interaction data 125 to determine what portions of the webpage other visitors interacted with. If, for example, 80% of the visitors to the website clicked on a first link but only 50% clicked on a second link, then the more popular link may be given a higher user-interest score.

In another embodiment, the webpage renderer 185 may be configured to assign a score based on the type of webpage element found in the sub-portion. If the webpage displays embedded videos, the webpage renderer 185 may be configured to give a higher user-interest score to the videos instead of the comments made by users who watched the video. Thus, the score may be assigned based on the links, multimedia, text, images, and other types of webpage elements contained within a sub-portion.

In another embodiment, the webpage renderer 185 may be configured to assign a score based on the structure of the webpage element. For example, the sub-portion may be in the primary frame of the webpage, for example, the top of the frame that typically contains the most recent blog post. Moreover, the sub-portion may contain tabs of the webpage that relate to the major divisions of the webpage—e.g., a sub-portion that includes tabs for the news, sports, weather, etc.

Furthermore, the webpage renderer 185 may consider a combination of the above mentioned criteria for assigning a score. For example, if the historical data 190 indicates that the user clicked on a link 70% of the time, but the visitor interaction data 125 indicates that other visitors clicked on the link 90% of time they visited the website, the webpage renderer 185 may consider both criteria when assigning the score. The webpage renderer 185 or the user may assign additional weights to the criteria to emphasize one criterion over another—e.g., the user's historical data 190 may be more important to determining relevance than the interaction data 125 from other visitors to the website.

At step 225, the webpage renderer 185 uses the score to identify a sub-portion of the webpage that is likely to be most relevant to the user. The user-interest score represents the likelihood that the user will find the corresponding portion relevant. The higher the score, the more likely the portion will be relevant. Accordingly, the webpage renderer 185 may select the sub-portion with the highest score as the most relevant portion of the webpage.

In one embodiment, in addition to selecting the sub-portion with the highest score, the webpage renderer 185 may use a threshold to further ensure that the selection is accurate. For example, if the historical data 190 indicates that the user clicked on a link 30% of the time, viewed a portion of a text 30% of the time, and watched an embedded video 40% of the time, the scores for these portions may not be high enough to exceed the threshold. That is, the data is not sufficient to confidently determine what activity is the most relevant to the user. Accordingly, the user may adjust the thresholds to better ensure that the webpage renderer 185 does not mistakenly determine that a sub-portion of the page is the most relevant to the user.

At step 230, the webpage renderer 185 may display the relevant portion (i.e., the portion with the highest user-interest score) in the display screen 175. In one embodiment, this may require zooming in (or out) relative to what would have been displayed on a computing device that does not perform the method 200—e.g., the webpage shown in FIG. 3A.

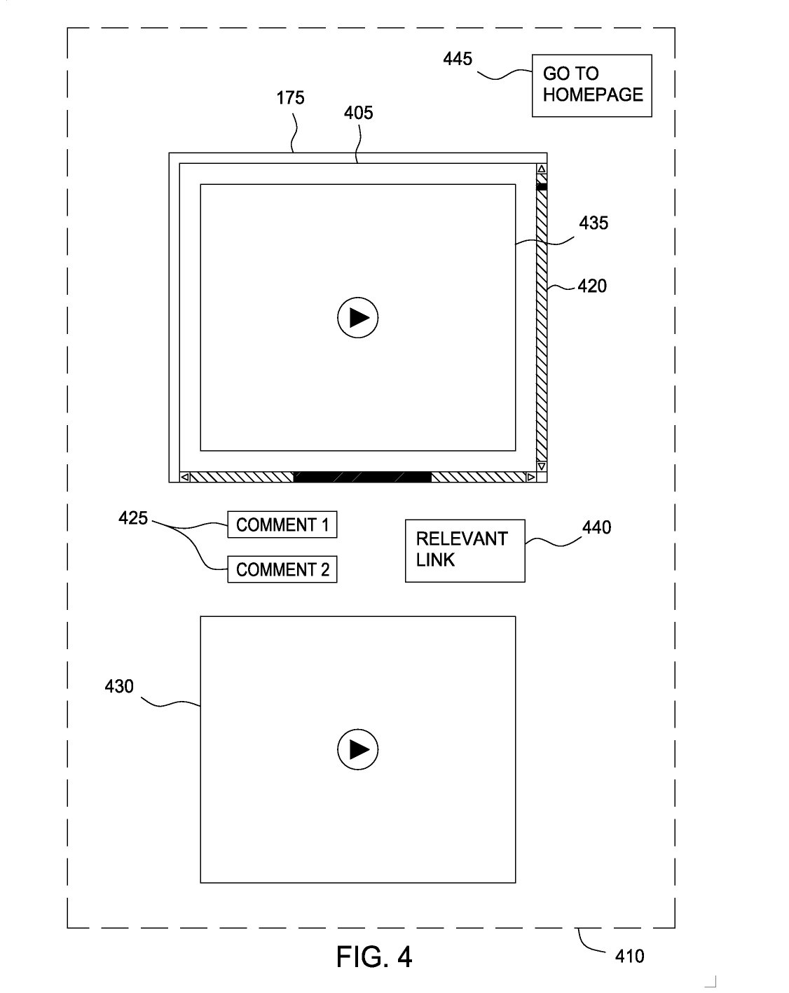

FIG. 4 illustrates zooming to display a relevant portion of the webpage, according to one embodiment of the invention. Specifically, FIG. 4 illustrates zooming in to a relevant portion 405 of the same webpage displayed in FIG. 3A. As shown, the dimensions of the display screen 175 remains constant but the webpage renderer 185 changes the zoom setting of the webpage (or the browser displaying the page) to provide the effect of zooming in. Moreover, the webpage renderer 185 may have panned the webpage to center the relevant portion 405 on the display screen 175. Accordingly, the webpage renderer 185 updated the scroll bars 420 and 415 to adjust for the new displayed portion.

In FIG. 4, the webpage renderer 185 identified the sub-portion of the webpage that included the embedded video 435 as the most relevant portion 405 of the webpage. In order to enhance the visibility of the embedded video 435, the webpage renderer 185 zoomed in thereby increasing the dimensions of the webpage elements 425, 430, 435, 440, and 445 on the display screen 175. This process also moved some of the content that was previously viewable in the display screen of FIG. 3A (i.e., image 345 and comments 325) to the unviewable portion 410 of the webpage (i.e., image 445 and comments 425).

In contrast to FIG. 3A, once the webpage renderer 185 zooms in to the relevant portion 405, the dimensions of the display screen 175, in both a lateral and vertical direction, become smaller than the dimensions of the webpage.

In one embodiment, the webpage renderer 185 may not zoom in to display the relevant portion. Instead, the renderer 185 may zoom out, pan, and/or scroll to display the relevant portion. For example, a computing device 170 may be configured to automatically display a zoomed in portion of the webpage. That is, in contrast to FIG. 3A where the computing device displays the webpage such that the width of the screen matches the width of the webpage, the device may set the zoom setting such that only the top leftmost corner of the webpage is displayed. Thus, the zoom setting may automatically make the text and images readable. Nonetheless, method 200 may be applied to pan to a portion that is likely to be most relevant to the user. Additionally, the webpage renderer 185 may zoom out to fit, for example, all of an embedded video in the most relevant portion onto the display screen.

### Displaying Links to Other Sub-Portions

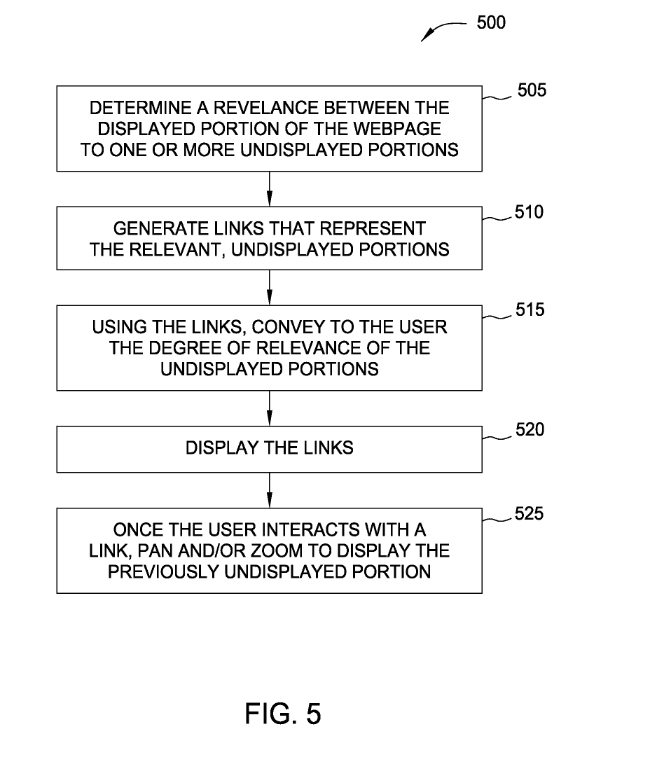

FIG. 5 is a flow chart describing a technique for displaying links to portions of the webpage that are not currently displayed, according to one embodiment of the invention. At step 505, the webpage renderer 185 determines the relevance between the currently displayed portion of the webpage to one or more unviewable portions.

In one embodiment, the method 500 occurs after the webpage renderer 185 has displayed the most relevant portion as determined by method 200 described in FIG. 2. Advantageously, the webpage renderer 185 can use the sub-portions already identified in step 220 of FIG. 2 to determine if they are relevant to the currently displayed portion. The webpage renderer 185 may parse the text of the sub-portions to see if their themes match the theme of the displayed portion. Or the renderer 185 may determine relevance based on whether the sub-portion includes similar webpage elements as the currently displayed portion—e.g., both portions include embedded videos. Further, the webpage renderer 185 may consider the structure of the webpage or the location of the portions, for example, whether the displayed portion is in the same webpage frame as a sub-portion.

The webpage renderer 185 may assign a relevance score to each of the sub-portions that represent similarities between the currently displayed portion of the webpage and the unviewable sub-portions. The user may customize the weights applied to determine the relevance score such as giving more weight to the textual analysis of the portions but less weight to the type of webpage elements contained in the portions. Moreover, the webpage renderer 185 may use a threshold to eliminate sub-portions whose relevance score is too low.

At step 510, the webpage renderer 185 generates links that represent the relevant portions that are currently not being displayed. The links may be icons, flashing indicators, animations, and the like. In one embodiment, the user may be able to interact with the links using a touch-sensitive display screen 175 or an I/O device. The webpage renderer 185 may generate a link for every sub-portion that has a relevance score that satisfies the threshold.

At step 515, the webpage renderer 185 uses the links to convey to user of the computing device a degree of relevance of the undisplayed contents in the unviewable sub-portion to the currently displayed content.

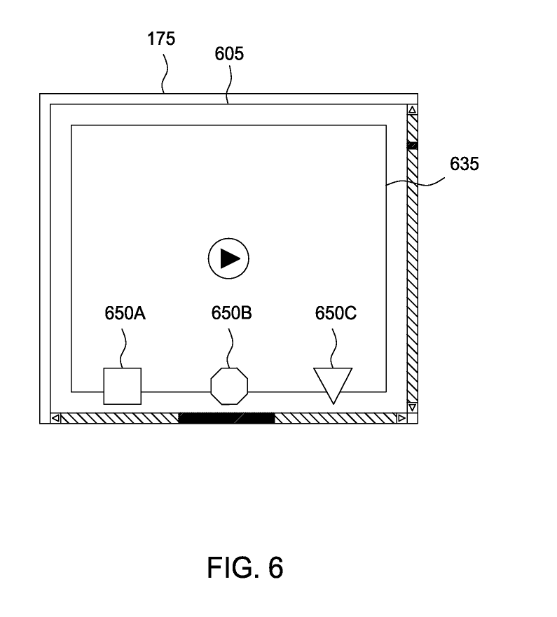

FIG. 6 illustrates displaying links to relevant, unviewable portions of the webpage, according to one embodiment of the invention. For clarity, the unviewable portion of the webpage is omitted from this figure. As shown, FIG. 6 displays the same relevant portion 605 that was displayed in FIG. 4 after the completion of method 200. However, the webpage renderer 185 superimposes the links 650 over the relevant portion 605 (i.e., the viewable portion of the webpage). The links 650 may be arranged in the display screen 175 based on the location of the sub-portions they represent in the webpage. For example, link 650C may represent a portion of the webpage that includes relevant link 440 and thus is in the lower right hand corner of the display screen 175.

In one embodiment, the links 650 are designed to convey to the user the relevance of the content in the sub-portion they represent to the content in the current viewable portion 605. Here, that relevance is conveyed by the shape of the link 650, or more specifically, the number of sides in the shape. Accordingly, the sub-portion represented by link 650B may contain content that is predicted to be more relevant to the embedded video player 635 than the content represented by link 650A or 650C. Of course, any other type of mechanism may be used to convey the degree of relevance such as a color scheme, animations, sounds, numbers, percentages, and the like.

The relevance score may be used to illustrate the degree of relevance of each sub-portion. For example, the webpage renderer 185 may compare each of the relevance scores and generate a link with a certain color to the sub-portion with the highest score, a different color for the next highest, etc. Alternatively, the webpage renderer 185 may compare the relevance score to one or more predefined thresholds. For example, if the relevance score is between 1-35 the link 650 is a triangle, if the score is between 36-70 the link 650 is a square, if the score is between 71-100 the link 650 is a pentagon, and so forth.

At step 520, the webpage renderer 185 displays the links 650 by, for example, superimposing the links above the currently viewable portion 605. Thus, the links 650 are displayed in addition to the content of the webpage, and thus, are not part of the webpage data 120 transmitted by the server 110.

In one embodiment, the links may be displayed on the screen 175 only after the user requests to view the links. For example, the computing device 170 may include a physical button, that when activated, instructs the webpage renderer 185 to display the links on the screen. Moreover, a touch-sensitive display screen 175 may set aside a portion of the screen that, once pressed by the user, displays the links. Alternatively, the links may displayed once the webpage renderer 185 completes method 200 and zooms in to the relevant portion. Or the webpage renderer 185 may display the links after the user has viewed the relevant portion for a predefined period of time.

Once the user selects a link 650 using a touch-sensitive display screen 175 or I/O device, at step 525, the webpage renderer 185 pans or zooms in order to display the previously unviewable portion of the webpage that corresponds to the link 650. In some instances, the webpage renderer 185 may zoom in or out (or not at all) when displaying the new sub-portion. For example, if the sub-portion contains text that would be too small, the webpage renderer 185 may zoom in to increase the text size of the display screen 175. Similarly, if the sub-portion includes another embedded video that has larger dimensions than the video 635, the webpage renderer 185 may zoom out to fit the entire video within the dimensions of the display screen 175. Alternatively, the webpage renderer 185 may only cause the display screen 175 to pan to the location of the sub-portion without changing the zoom.

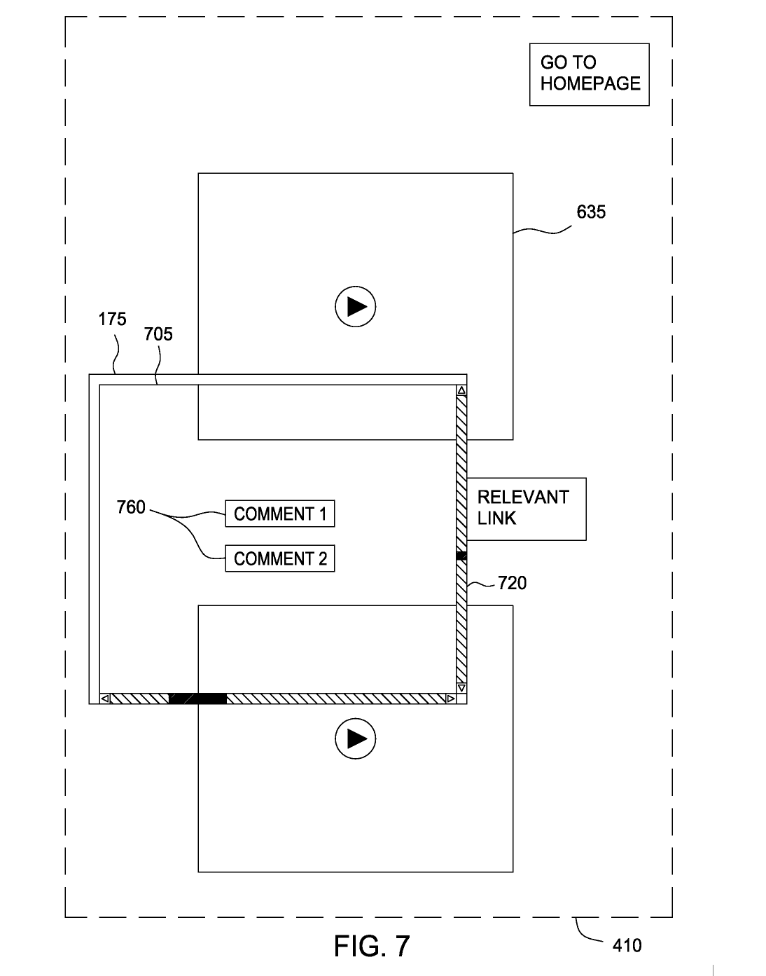

FIG. 7 illustrates panning or zooming to display a portion of the webpage based on a user interaction with a link, according to one embodiment of the invention. Specifically, FIG. 7 illustrates the results of selecting a link that corresponds to the portion that contains the comments 760. Accordingly, the webpage renderer 185 panned the display screen 175 such that the viewable portion 705 now includes the comments 760. The horizontal and vertical scroll bars 715, 720 were updated to indicate that the panning took place. Further, a portion of the embedded video 635 is still viewable in the display screen 175. Thus, the different sub-portions of the webpage may overlap depending on the desired size of the contents in the sub-portions and the proximity of contents within the webpage.

In this manner, the user is able to use the links to efficiently zoom or pan (or both) through the display screen 175 to view content that is related to what is currently being displayed.

### Displaying Hotspots as a User Zooms Out

Instead of using a link to automatically pan to a different portion of the webpage, the user may zoom out to move more of the webpage's content onto the display screen. Doing so provides the computing device with another opportunity to highlight areas that may be of interest to the user.

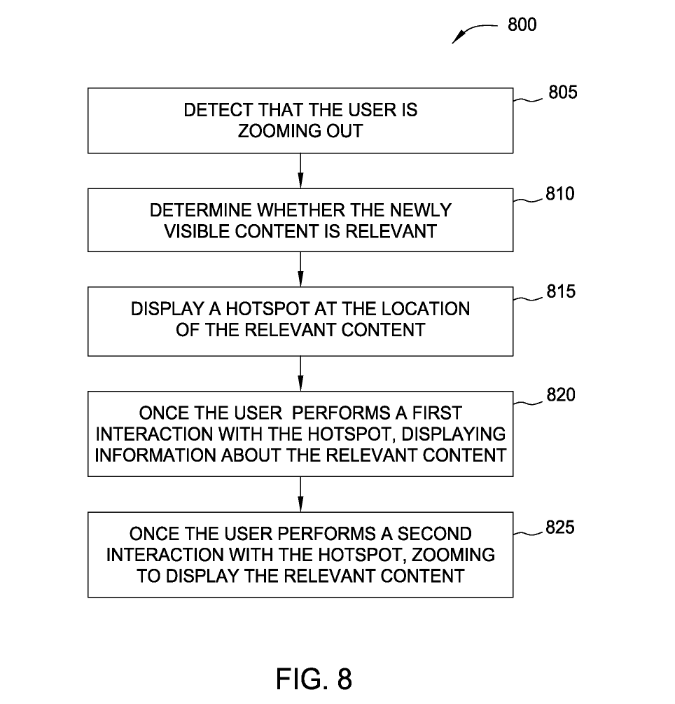

FIG. 8 is a flow chart describing a technique 800 for displaying points of interests, according to one embodiment of the invention. At step 805, the webpage renderer 185 detects that the user has instructed the computing device 170 to zoom out from the currently displayed portion. In one embodiment, the currently displayed portion is the same as the portion that was displayed at the end of method 200 as shown in relevant portion 405 of FIG. 4.

Zooming out changes the difference between the dimensions of the display screen 175 and the dimensions of the webpage. Because the dimensions of the display screen 175 are typically fixed, shrinking the dimensions of the webpage in the lateral or horizontal directions moves content from the unviewable portion of the webpage into the viewable portion of the display screen 175.

At step 810, the webpage renderer 185 determines whether the content that is moved from the unviewable portion into the viewable portion is relevant to what was displayed on the display screen 175 before the user began to zoom out. Thus, even if the user zooms out in stages (i.e., the user submits a series of requests to zoom out), the webpage renderer 185 continues to determine whether the new content is relevant to what was originally displayed at the end of step 230 of method 200. Moreover, the webpage renderer 185 may make this determination before or after the content is moved onto the display screen 175.

To determine if the content is relevant, the webpage renderer 185 may use the same analysis that was described in method 500 of FIG. 5 for determining if sub-portions associated with the links are similar or related to the currently displayed portion, which will not be repeated here.

At step 815, the webpage renderer 185 may mark the point of interest (i.e., hotspot) that corresponds to a location of a sub-portion that contains content relevant to the content that was displayed before the user zoomed out.

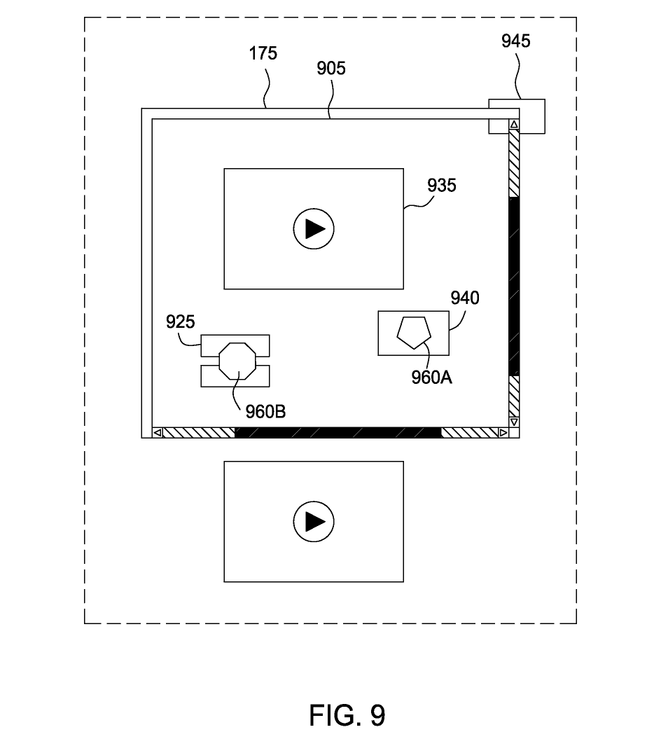

FIG. 9 illustrates displaying points of interests on the display screen of the computing device, according to one embodiment of the invention. Specifically, FIG. 9 illustrates a zoomed out view of the webpage shown in FIG. 4. As the webpage renderer 185 zooms out, more of the webpage's content moves into the viewable portion 905—e.g., image 945, comments 925, and relevant link 940. As shown, the comments 925 and relevant link 940 are predicted as being relevant to the content (i.e., embedded video 935) that was displayed before the user zoomed out. Accordingly, the webpage renderer 185 places points of interest 960A and 960B at the location of the sub-portions that include this relevant content. In one embodiment, the image 945 may not be relevant to the previously displayed content, and thus, does not have a point of interest 960 assigned. Alternatively, even if the image 945 is relevant to the video 935, the webpage renderer 186 may wait until all of the sub-portion that contains the image 945 is displayed before superimposing a point of interest 960 onto the display screen.

Like the links 650 shown in FIG. 6, the points of interests 960 may similarly be designed to illustrate the degree of relevance of the content they represent. Thus, point of interest 960B may represent content that is more relevant to embedded video 935 than point of interest 960A. The design of the points of interest 960 may be updated to illustrate the degree of relevance as the user continues to zoom out and more content is moved into the viewable portion 905.

Because the points of interests are superimposed onto the display screen 175 and are not part of the webpage data 120, they may continue to have the same size and visibility on the display screen 175 as the user zooms out. That is, even though zooming out may shrink the text and images until they are no longer understandable, the webpage renderer 185 may maintain the size or zoom setting of the points of interests 960 such that they remain readable to the user.

At step 820, upon detecting that the user performs a first interaction with the point of interest 960, the webpage renderer 185 may display a summary of the content that corresponds to the point of interest 960. For example, when a user taps once on the screen 175 or hovers a cursor over the point of interest 960, the webpage renderer 185 may superimpose a brief explanation of the underlying content onto the screen 175. Advantageously, the webpage renderer 185 may display this summary at a zoom setting that is readable to the user even if the underlying content is not. That is, the webpage renderer 185 may treat the summary and points of interest 960 independently of the underlying webpage. An example of summary for point of interest 960B may be “comments made by users about the embedded video”. In this manner, the user is able to zoom out and traverse through the different summaries provided by the points of interest 960 without having to zoom in to view text or images located in the sub-portions.

To generate the summaries, the webpage renderer 185 may use the same data analysis it used to when determining whether the content of the sub-portion is related to the previously displayed content. For example, the summaries may be based on whether both portions have the same webpage elements or pertain to the same topic. Of course, webpage renderer 185 may use this process to provide summaries for the links that were discussed in method 500 of FIG. 5.

At step 825, upon detecting that the user performs a second action with the point of interest 960, the webpage renderer 185 may pan or zoom in to display the content related to the point of interest 960. If the text is still readable, then the webpage renderer 185 may only pan to the sub-portion of the point of interest 960 such that the portion is centered on the display screen 175. Alternatively, the webpage renderer 185 may zoom in as well as pan in order to display the sub-portion. For example, if the user performs the second action (e.g., tapping twice on the point of interest or clicking with the left mouse button) on point of interest 960B that is associated with the comments 925, the result may be the same as what is shown in FIG. 7 where the display screen 175 both pans and zooms in to display the comments 760 in the viewable portion 705.

In another embodiment, the points of interest 960 may be displayed even when the user does not zoom out of the webpage. Accordingly, when a user first visits the webpage, the points of interest 960 may be displayed according to the embodiments above. The points of interest 960 may the locations on the webpage that are related to content on a webpage that the user was previously viewing before navigating to the current page or be based on historical information from the user's past visits to the current webpage.

### Conclusion

Once a computing device receives a request to display a webpage, the device may use criteria to determine the portion of the page that is likely to be the most relevant to the user. The computing device may then zoom in (i.e., adjust the relative size and position of the elements in the webpage) and pan or scroll through the webpage such that the most relevant portion is displayed. Additionally, the computing device may superimpose on the displayed portion of the webpage links that represent other portions of the webpage that are currently not displayed but are relevant to the currently displayed portion. Selecting a link causes the computing device to display the corresponding portion. Furthermore, as the user zooms out, the computing device may also highlight hotspots or points of interests for the new content that is being displayed. A hotspot is identified based on the relevance of the newly displayed content to what was being displayed before the user began to zoom out.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the foregoing is directed to embodiments of the present invention, other and further embodiments of the invention may be devised without departing from the basic scope thereof, and the scope thereof is determined by the claims that follow.

What is claimed is:

1. A method of displaying a webpage on a screen of a computing device, comprising:
receiving a command to display the webpage on the screen;
determining a size of a plurality of sub-portions of the webpage based on a minimum object size for displaying the object on the screen;
determining a user-interest score for each of the sub-portions based on previous interactions with at least one of: the webpage and a webpage element or a type of webpage element contained in the sub-portions, the user-interest score representing the likelihood that the user of the computing device is interested in one or more webpage elements contained in the sub-portions;
selecting a relevant sub-portion from among the sub-portions based on the respective user-interest scores;
upon determining that the user-interest score for the relevant sub-portion satisfies a predefined threshold, zooming in and panning the web page to display the relevant sub-portion of the web page on the screen such that lateral and vertical dimensions of the webpage exceed both of the lateral and vertical dimensions of the screen, whereby an unviewable portion of the webpage comprises a lateral portion and a vertical portion of the webpage;
after displaying the relevant sub-portion of the webpage:
displaying a link in the screen that instructs the computing device to display in the screen a different portion of the webpage that is at least partially within the unviewable portion of the webpage; and
upon determining that the user interacted with the link, displaying in the screen the different portion of the webpage such that the relevant sub-portion of the webpage is at least partially within the unviewable portion of the webpage.

2. The method of claim 1, wherein the object is at least one of text, a graphic, and a image.

3. The method of claim 1, further comprising:
before displaying the link, determining a relevance score between a content in the relevant portion of the webpage and a content in the different portion of the webpage, the relevance score representing the similarities between the content in the relevant portion and the content in the different portion; and
upon determining that the relevance score satisfies a predefined relevance threshold, generating the link to display in the screen.

4. The method of claim 1, further comprising:
receiving a command from the user to change at least a portion of the content currently being displayed on the screen such that additional content of the webpage is displayed by zooming out; and
displaying a point of interest at a location on the webpage, wherein, before receiving the command from the user to change the content being displayed on the screen by zooming out, the location was in the unviewable portion of the webpage.

5. The method of claim 4, further comprising, before displaying the point of interest:
determining a relevance score between a content in the relevant sub-portion of the webpage and a content at the location of the webpage, the relevance score representing the similarities between the content in the relevant sub-portion and the content at the location of the webpage; and
upon determining that the relevance score satisfies a predefined relevance threshold, generating the point of interest to display in the screen.

6. The method of claim 4, further comprising:
upon detecting that the user performs a first interaction with the point of interest, displaying information about the content at the location of the webpage; and
upon detecting that the user performs a second interaction with the point of interest, displaying in the screen the content at the location of the webpage such that the relevant sub-portion of the webpage is at least partially within the unviewable portion of the webpage.

7. The method of claim 1, further comprising, determining what content of the webpage to include in each of the plurality of sub-portions based on: previous interactions of a user of the computing device with the relevant sub-portion, previous interactions by a plurality of other visitors to the webpage with the relevant sub-portion, textual analysis of the webpage, and a content or structure of the webpage.

8. A computer program product of displaying a webpage on a screen of a computing device, the computer program product comprising:
a computer-readable storage medium having computer-readable program code embodied therewith, the computer-readable program code comprising computer-readable program code configured to:
receive a command to display the webpage on the screen;
determine a size of a plurality of sub-portions of the webpage based on a minimum object size for displaying the object on the screen;
determine a user-interest score for each of the sub-portions based on at least one of: previous interactions with the webpage and a webpage element or a type of webpage element contained in the relevant sub-portion, the user-interest score representing the likelihood that the user of the computing device is interested in webpage elements contained within the sub-portions;
select a relevant sub-portion from among the sub-portions based on the respective user-interest scores;
upon determining that the user-interest score for the relevant sub-portion satisfies a predefined threshold, zoom in and panning the web page to display the relevant sub-portion of the web page on the screen such that lateral and vertical dimensions of the webpage exceed both of the lateral and vertical dimensions of the screen, whereby an unviewable portion of the webpage comprises a lateral portion and a vertical portion of the webpage;
after displaying the relevant sub-portion of the webpage:
display a link in the screen that instructs the computing device to display in the screen a different portion of the webpage that is at least partially within the unviewable portion of the webpage; and
upon determining that the user interacted with the link, display in the screen the different portion of the webpage such that the relevant sub-portion of the webpage is at least partially within the unviewable portion of the webpage.

9. The computer program product of claim 8, wherein the object is at least one of text, a graphic, and a image.

10. The computer program product of claim 8, further comprising computer-readable program code configured to:
before displaying the link, determine a relevance score between a content in the relevant sub-portion of the webpage and a content in the different portion of the webpage, the relevance score representing the similarities between the content in the relevant sub-portion and the content in the different portion; and
upon determining that the relevance score satisfies a predefined relevance threshold, generate the link to display in the screen.

11. The computer program product of claim 8, further comprising computer-readable program code configured to:
receive a command from the user to change at least a portion of the content currently being displayed on the screen such that additional content of the webpage is displayed by zooming out; and
display a point of interest at a location on the webpage, wherein, before receiving the command from the user to change the content being displayed on the screen by zooming out, the location was in the unviewable portion of the webpage.

12. The computer program product of claim 11, further comprising computer-readable program code configured to, before displaying the point of interest:
determine a relevance score between a content in the relevant sub-portion of the webpage and a content at the location of the webpage, the relevance score representing the similarities between the content in the relevant sub-portion and the content at the location of the webpage; and
upon determining that the relevance score satisfies a predefined relevance threshold, generate the point of interest to display in the screen.

13. The computer program product of claim 11, further comprising computer-readable program code configured to:
upon detecting that the user performs a first interaction with the point of interest, display information about the content at the location of the webpage; and
upon detecting that the user performs a second interaction with the point of interest, display in the screen the content at the location of the webpage such that the relevant sub-portion of the webpage is at least partially within the unviewable portion of the webpage.

14. The computer program product of claim 8, further comprising computer-readable program code configured to, determine what content of the webpage to include in each of the plurality of sub-portions based on: previous interactions of a user of the computing device with the relevant sub-portion, previous interactions by a plurality of other visitors to the webpage with the relevant sub-portion, textual analysis of the webpage, and a content or structure of the webpage.

15. A system, comprising:
a computer processor; and
a memory containing a program that, when executed on the computer processor, performs an operation for processing data, comprising:
receiving a command to display the webpage on the screen;
determining a size of a plurality of sub-portions of the webpage based on a minimum object size for displaying the object on the screen;
determining a user-interest score for each of the sub-portions based on at least one of: previous interactions with the webpage and a webpage element or a type of webpage element contained in the relevant sub-portion, the user-interest score representing the likelihood that the user of the computing device is interested in webpage elements contained within the sub-portions;
selecting a relevant sub-portion from among the sub-portions based on the respective user-interest scores;
upon determining that the user-interest score for the relevant sub-portion satisfies a predefined threshold, zooming in and panning the web page to display the relevant sub-portion of the web page on the screen such that lateral and vertical dimensions of the webpage exceed both of the lateral and vertical dimensions of the screen, whereby an unviewable portion of the webpage comprises a lateral portion and a vertical portion of the webpage;
after displaying the relevant sub-portion of the webpage:
displaying a link in the screen that instructs the computing device to display in the screen a different portion of the webpage that is at least partially within the unviewable portion of the webpage; and
upon determining that the user interacted with the link, displaying in the screen the different portion of the webpage such that the relevant sub-portion of the webpage is at least partially within the unviewable portion of the webpage.

16. The system of claim 15, wherein the object is at least one of text, a graphic, and a image.

17. The system of claim 15, further comprising:
before displaying the link, determining a relevance score between a content in the relevant sub-portion of the webpage and a content in the different portion of the webpage, the relevance score representing the similarities between the content in the relevant sub-portion and the content in the different portion; and
upon determining that the relevance score satisfies a predefined relevance threshold, generating the link to display in the screen.

18. The system of claim 15, further comprising:
receiving a command from the user to change at least a portion of the content currently being displayed on the screen such that additional content of the webpage is displayed by zooming out; and
displaying a point of interest at a location on the webpage, wherein, before receiving the command from the user to change the content being displayed on the screen by zooming out, the location was in the unviewable portion of the webpage.

19. The system of claim 18, further comprising, before displaying the point of interest:
determining a relevance score between a content in the relevant sub-portion of the webpage and a content at the location of the webpage, the relevance score representing the similarities between the content in the relevant sub-portion and the content at the location of the webpage; and
upon determining that the relevance score satisfies a predefined relevance threshold, generating the point of interest to display in the screen.

20. The system of claim 18, further comprising:
upon detecting that the user performs a first interaction with the point of interest, displaying information about the content at the location of the webpage; and
upon detecting that the user performs a second interaction with the point of interest, displaying in the screen the content at the location of the webpage such that the relevant sub-portion of the webpage is at least partially within the unviewable portion of the webpage.
